(19) United States
(12) Patent Application Publication
(10) Pub. No.: US 2024/0033173 A1
(43) Pub. Date: Feb. 1, 2024

(54) REAL TIME ADJUSTABLE AMPLITUDE AND ADJUSTABLE FREQUENCY PERCUSSIVE THERAPY DEVICE

(71) Applicant: Nice Recovery Systems LLC, Boulder, CO (US)

(72) Inventors: Lou Busick, Westerville, OH (US); Joel Meisinger, Boulder, CO (US); Michael Ross, Boulder, CO (US); Stephen Wharton, Grandview Heights, OH (US)

(21) Appl. No.: 17/874,842

(22) Filed: Jul. 27, 2022

(51) Int. Cl. A61H 23/00; A61H 23/02

(52) U.S. Cl. CPC A61H 23/006; A61H 23/0254; A61H 2201/1472; A61H 2201/149; A61H 2201/1664

(57) ABSTRACT

An electronic device for percussive massage therapy. The device includes a reciprocating member configured to move at any number of different amplitudes and frequencies. In one example, the device is configured with a number of gears including a planetary gear, a ring gear, and a positioning gear, which permit amplitude to be varied between a great number of amplitudes within a predetermined range. The user may adjust frequency and amplitude of the reciprocating member in real time. In one example, the reciprocating member is adapted to vibrate to permit vibration therapy in addition to percussive therapy.

### CROSS-REFERENCE TO RELATED APPLICATIONS

This application is filed as original and makes no priority claim.

### TECHNICAL FIELD

Embodiments of the present disclosure relate to an electronic device for massage therapy, the device adapted to permit movement of a reciprocating member to be varied between a number of different amplitudes and frequencies while in operation. In one example embodiment, the device is configured with a number of gears, including a planetary gear, a ring gear, and a positioning gear permitting amplitude to be varied in real time between a plurality of amplitudes. In some alternative embodiments, the reciprocating member is adapted to vibrate to permit vibration therapy.

### BACKGROUND AND SUMMARY OF THE INVENTION

Traditionally, massage therapy has been performed by hand or with non-motorized devices or apparatuses. An issue with traditional massage therapy is the human ability to engage tissues at certain speeds, ranges of motion, patterns, some combination thereof, or the like is limited. Another issue with traditional massage therapy is an individual, namely a massage therapist, is required to perform the massage therapy. The development of motorized massage machines has enabled massage therapy to occur without the same speed, range of motion, pattern, or the like restrictions present with traditional massage therapy, and without the need for an individual, such as a massage therapist, to perform the massage therapy. A non-limiting example of a motorized massage machine is a percussive therapy massage apparatus. A percussive therapy massage apparatus is an apparatus having a reciprocating member having a distal end configured to apply a force to a tissue during each reciprocation of the member. One advantage of therapy involving a percussive therapy massage apparatus (referred to herein as “percussive massage therapy”) is that a substantial number of forces to a tissue may be exerted over a short amount of time to promote certain muscle benefits.

An issue with prior art percussive massage therapy is that the prior percussive therapy massage apparatuses (referred to herein as “prior apparatuses”) are limited to either no options for varying amplitude (also referred to herein as “stroke”), or only a small, finite number of options for varying stroke, where amplitude/stroke is defined as the maximum difference in distance of the position of the front of the reciprocating member when the member is in an extended position compared to a retracted position. This issue may limit a user's ability to experience a specific desired stroke based on any number of different treatment requirements or preferences. Another issue with prior art percussive massage therapy is that the prior apparatuses generally involve many component parts operating according to largely complex gearing mechanisms. This issue may increase manufacturing costs and labor, repair costs, and labor, energy requirements, space usage requirements, device weight, some combination thereof, or the like for the apparatuses beyond optimal parameters. Yet another issue with prior apparatuses is that prior apparatuses lack combined real time stroke and frequency adjustment control, where frequency is defined as the number of pulses or percussions (achieved when the reciprocating member moves from a retracted position to an extended position and back to a retracted position) occurring in a certain amount of time. This issue may limit a user's ability to adjust stroke and frequency during treatment to, for example by way of illustration and not limitation, maintain muscle comfort during treatment, increase forces applied to tissues after loosening up the tissues with smaller and/or less prevalent forces to maximize treatment efficiency, some combination thereof, or the like.

The aforementioned shortcomings speak to the need for a percussive therapy device configured with adjustable amplitude and adjustable frequency, wherein adjustments may occur in real time, including by way of example and not limitation, during an ongoing therapy session without need of stopping the ongoing operation of the device to change settings.

It is an object of the present invention to provide a lightweight, durable and affordable percussive therapy device useful for promoting and maintaining muscle comfort, health, strengthening, flexibility, pain management, increased range of muscle motion, some combination thereof or the like.

In view of the prior art shortcomings and the aforementioned object, exemplary embodiments of the present invention provide a real time infinitely adjustable amplitude and adjustable frequency percussive therapy device.

According to the present invention in one aspect, an exemplary device comprises a piston defining a reciprocating member, a handle permitting a user to hold the device, and a housing surrounding a plurality of gears (also referred to herein as a “gear assembly”) positioned on or in close proximity to a frame, a connecting rod, and at least one motor. The plurality of gears may include a planetary gear positioned adjacent to idler gears, rollers, some combination thereof, or the like (referred to herein collectively or independently as “cushioning devices”) wherein the cushioning devices may be adapted to maintain the planetary gear in a substantially central position with respect to the gear assembly. The idler gears, rollers, some combination thereof, or the like may be positioned adjacent to an interior circumference of a ring gear, and above an eccentric drive unit linked to a drive motor. In preferred embodiments, a therapy feature, such as by way of example and not limitation, an attachment having an ellipsoidal or substantially spherical surface, may be positioned at or near a distal end of the reciprocating member and adapted to contact the body of a user. A worm gear, threaded shank, or the like (independently or collectively, “positioning gear(s)”) may be adapted to engage the ring gear to dictate the stroke of the piston between an infinite number of different strokes within a predetermined range.

A drive motor axle may be adapted to cause rotation of an eccentric drive unit attached thereto, the eccentric drive unit having an off-center axle configured to contact the planetary gear and contribute to movement thereof. An off-center axle of the planetary gear may be adapted to be received by a first bearing of a connection rod (also referred to herein as a “connecting rod”) at a first end of the connection rod, wherein the bearing may be useful to reduce friction between the off-center axle and the connecting rod. The planetary gear may comprise a plurality of gear teeth around a perimeter thereof adapted to engage corresponding gear teeth positioned along an inner circumference of the ring gear. A second bearing of the connection rod, positioned at a second end of the connection rod opposite of the first end, may include an attachment member positioned therein adapted to connect the connection rod to the piston. It will be apparent to one of ordinary skill in the art that any number of different motors may be employed to actuate an exemplary eccentric drive unit without departing from the scope of the present invention.

A lubricated bushing may substantially surround a circumference of the piston, and the lubricated bushing may be adapted to cause the piston to move in a linear fashion. Rotation of the eccentric drive unit caused by the drive motor may cause the planetary gear to rotate and orbit along the inner circumference of the ring gear. The aforementioned movement of the planetary gear may cause the planetary gear off-center axle to move in a substantially ellipsoidal or substantially linear path, which may cause movement of the connecting rod which may drive the piston in a linear, reciprocating motion resulting in a stroke thereof. The drive motor may be adapted to cause the eccentric drive unit to rotate at any number of different velocities. Rotation of the eccentric drive unit may be adjusted in real time, including by way of example and not limitation, during an ongoing percussive therapy session, by a central controller. Adjusting rotation of the eccentric drive unit in real time may directly change the reciprocating member movement frequency in real time.

The worm gear, threaded shank, or the like may be configured to cause rotation of the ring gear in real time, including by way of example and not limitation, during an ongoing percussive therapy session. Rotation of the ring gear in real time may cause movement of the planetary gear axle to be repositioned in real time between an infinite number of different pathways (within a predetermined range), resulting in an infinite number of different available strokes within a predetermined range. Movement of the worm gear, threaded shank, or the like (for actuating the ring gear) may be achieved by a button, a stepper motor, a rotatable dial, a rotatable nob, a touch screen control, some combination thereof, or the like.

It will be apparent to one of ordinary skill in the art that an exemplary positioning gear may be any number of different shapes and/or sizes without departing from the scope of the present invention. It will further be apparent to one of ordinary skill in the art that each of the aforementioned gears may be any number of different shapes and/or sizes without departing from the scope of the present invention. It will also be apparent to one of ordinary skill in the art that the present invention may further comprise any number of other different gears without departing from the scope of the present invention. It will additionally be apparent to one of ordinary skill in the art that any number of different modifications to the exemplary gear configurations described herein may be made without departing from the scope of the present invention.

With exemplary embodiments, therapeutic effects/benefits to muscle comfort, tissue health, muscle strengthening, increasing range of muscle motion, tissue flexibility, pain management, some combination thereof, or the like may be achieved in a fraction of the time required to achieve such benefits with traditional massage therapy. The exemplary option to vary stroke in real time between a great many different available strokes, and to vary frequency in real time may permit a user to, for example by way of illustration and not limitation, loosen up muscles with a smaller amplitude and/or frequency strokes and then maximize treatment efficiency by contacting loosened up muscles with larger amplitude and/or higher frequency strokes later on during a single percussive therapy session.

As another non limiting example, the exemplary option to vary stroke in real time between a great number of different available strokes, and to vary frequency in real time may permit a user to adjust amplitude and/or frequency as preferred during the duration of a single percussive therapy session to achieve and/or maintain a desired muscle comfort level as the session progresses. In the aforementioned example, if a user is not yet feeling anticipated sensations from percussive therapy, the user may increase amplitude and frequency of the reciprocating member to large parameters to increase muscle impacts without first having to end the session. In the aforementioned example, where muscle impacts have been significant for an extended amount of time, the user may decrease amplitude and frequency of the reciprocating member to very small parameters without first having to end the session, such as to, by way of example and not limitation, prevent adverse effects on muscle fibers. In certain embodiments, stroke and frequency may be specified and/or adjusted according to digital interface programming before and/or during percussive therapy. In certain embodiments, a user may begin with local vibration therapy on a particularly sore muscle group where percussive therapy may be too painful at that time for the sore muscle group. As the vibration therapy session progresses, pain levels at the muscle group may decrease, permitting the user to progress toward percussive therapy to assist with, by way of example and not limitation, range of muscle motion and athletic performance.

Exemplary embodiments of the present invention may reduce and/or delay muscle stiffness and soreness after a workout, and contribute to muscle recovery after a workout. Exemplary embodiments of the present invention may further promote optimal muscle compliance and movement velocity, and acutely increase range of muscle motion. Exemplary embodiments of the present invention may also be beneficial for loosening muscles, such as for, by way of example and not limitation, performing a warm-up regiment to improve muscle flexibility without losing muscle performance. Exemplary embodiments of the present invention may additionally contribute to decreased muscle fatigue.

In another example embodiment, the reciprocating member and/or an attachment thereon at a distal end thereof are configured to vibrate (referred to herein as “local vibration therapy”) during percussive therapy. Local vibration therapy, especially in combination with exemplary percussive therapy, may contribute to prevention of delayed onset muscle soreness. Additionally, local vibration therapy, especially in combination with exemplary percussive therapy, may promote muscle power development and performance, flexibility, kinesthetic awareness, range of motion, blood flow, some combination thereof, or the like. Local vibration therapy may also contribute to a reduced risk of rhabdomyolysis. It will be apparent to one of ordinary skill in the art that exemplary embodiments of the present invention may contribute any number of different benefits to muscle comfort, health, strengthening, flexibility, some combination thereof or the like. It will further be apparent to one of ordinary skill in the art that although embodiments described herein relate to a percussive therapy device for promoting and maintaining muscle comfort, health, strengthening, flexibility, some combination thereof or the like, exemplary embodiments may be useful to any number of other different endeavors.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates a perspective view of an exemplary embodiment of the present invention;

FIG. 2 illustrates a top plan view of the FIG. 1 embodiment;

FIG. 3 illustrates a right-side, cross-sectional view of the FIG. 1 embodiment;

FIG. 4 illustrates another top plan view of the FIG. 1 embodiment frame, piston, and gear assembly;

FIG. 5 illustrates top plan views of exemplary stroke variability in accordance with the FIG. 1 embodiment;

FIG. 6 illustrates an exploded perspective view of another exemplary embodiment of the present invention;

FIG. 7 illustrates a top plan view of the FIG. 6 embodiment frame, piston, and gear assembly;

FIG. 8 illustrates a first exemplary stroke of the FIG. 6 embodiment;

FIG. 9 illustrates a second exemplary stroke of the FIG. 6 embodiment;

FIG. 10 illustrates a perspective view of another exemplary embodiment of the present invention;

FIG. 11 illustrates a top view of the FIG. 10 embodiment;

FIG. 12 illustrates exemplary logic for various device interfaces in accordance with a preferred embodiment of the present invention;

FIG. 13 illustrates a top view of another exemplary embodiment of the present invention wherein a planetary gear off-center axle is in a first position; and

FIG. 14 illustrates a top view of the FIG. 13 embodiment wherein the planetary gear off-center axle is in a second position.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

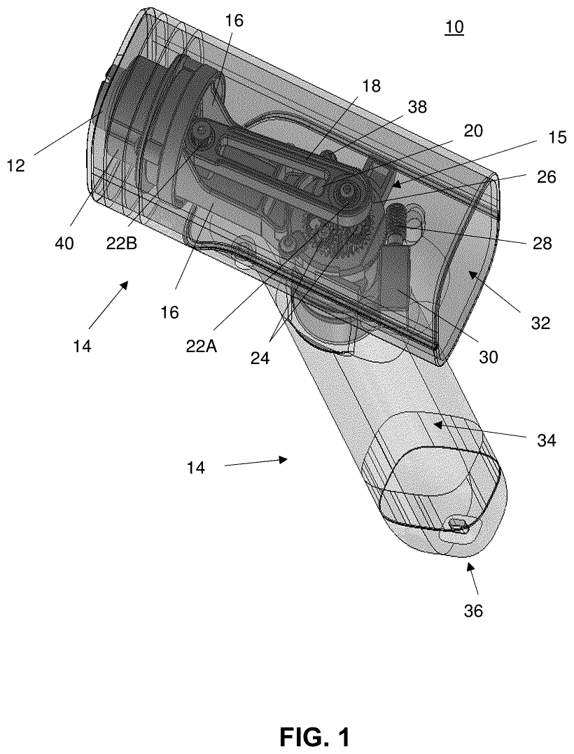

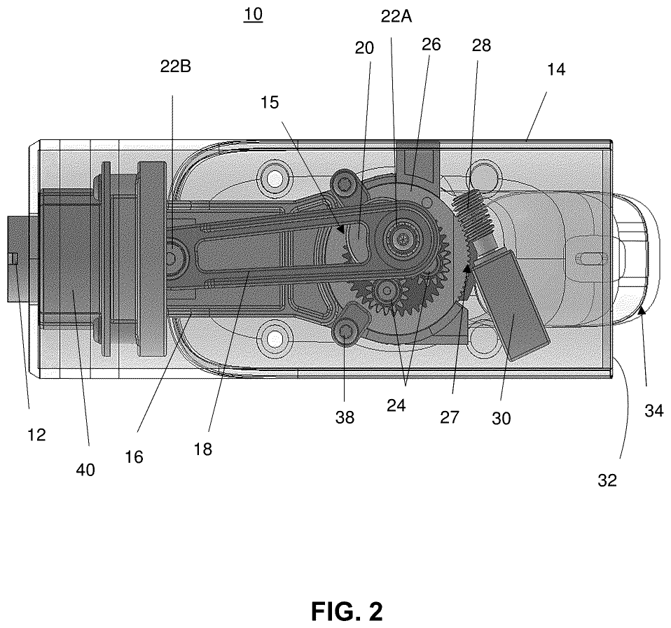

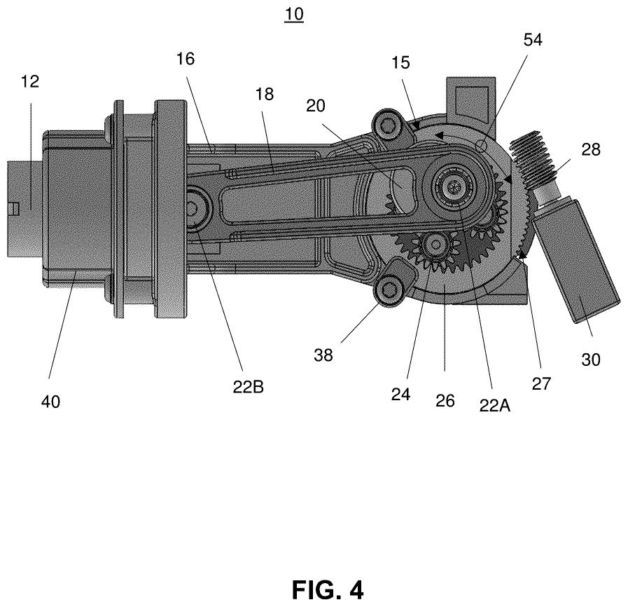

Referring now to FIGS. 1-2 and 4, an exemplary real time infinitely adjustable amplitude and adjustable frequency percussive therapy device 10 is shown, wherein the housing 14 is shown as transparent merely for illustrative purposes. The exemplary device 10 comprises a piston 12 defining a reciprocating member, and a handle 34 permitting a user to hold and position the device 10, such as by hand. The housing 14 may contain therein a gear assembly 15 positioned on or in close proximity to a frame 16, wherein the frame 16 may be adapted to support the gear assembly 15, a bushing (e.g., 40) and a connection rod 18. A motor may be positioned below the gear assembly 15, and may be powered by a battery positioned in the handle 34 with a charge connection 36. It will be apparent to one of ordinary skill in the art that there may be any number of different devices or methods available for powering one or more exemplary motors without departing from the scope of the present invention.

The gear assembly 15 may include a planetary gear 20 positioned adjacent to idler gears 24. The idler gears 24 may be adapted to maintain the planetary gear 20 in a substantially central position with respect to the gear assembly 15. In this particular embodiment, the idler gears 24 are adapted to reduce the impact of the gear assembly 15 on the device 10 motor shaft, which may prevent deflection of the motor shaft caused by excessive force from the gear assembly 15, which may prevent the planetary gear 20 from being disengaged from the ring gear 26. Alternatively, or additionally, a roller and/or similar other cushioning device may be positioned adjacent to the planetary gear 20, may be adapted to maintain the planetary gear 20 in a substantially central position with respect to the gear assembly 15, and may further be adapted to reduce the impact of the gear assembly 15 on the device motor shaft. An exemplary roller may also be beneficial for reducing device 10 noise. The gear assembly 15 may be secured to the frame 16 by any number of different fasteners (e.g., 38), clips, bolts, welding, some combination thereof, or the like. It will be apparent to one of ordinary skill in the art that there may be any number of different materials, devices or methods available for preventing exemplary gears from becoming disengaged from one another.

The idler gears 24 may be positioned adjacent to an interior circumference of a ring gear 26. In preferred embodiments, a therapy feature, such as by way of example and not limitation, an attachment having an ellipsoidal or substantially spherical surface, may be positioned at or near a distal end of the piston 12, and may be adapted to contact the body of a user. The attachment may comprise a plug-in head, and the piston 12 may be adapted to receive the plug-in head, such as by way of example and not limitation, through groove and o-ring connection features. The piston and the plug-in head may exert force on a user's tissue through the reciprocating motion of the piston while the device 10 is active. In certain embodiments, the piston is adapted to withstand forces ranging from 40 to 60 pounds without stalling. It will be apparent to one of ordinary skill in the art that an exemplary piston may be adapted to receive any number of different plug-in heads of any number of different shapes and sizes. It will further be apparent to one of ordinary skill in the art that the present invention is not necessarily intended to be limited to a single reciprocating member.

An off-center axle of the planetary gear 20 may be adapted to be received by a first bearing 22A of the connection rod 18 at a first end of the connection rod 18, wherein the bearing 22A may be useful to reduce friction between the off-center axle and the connecting rod 18. The planetary gear 20 may comprise a plurality of gear teeth around a perimeter thereof adapted to engage corresponding gear teeth positioned along an inner circumference of the ring gear 26. A second bearing 22B of the connection rod 18, positioned at a second end of the connection rod 18 opposite of the first end, may include an attachment member positioned therein adapted to connect the connection rod to the piston. It will be apparent to one of ordinary skill in the art that an exemplary connection rod may be any number of different shapes and/or sizes, and is not necessarily limited to two bearings.

A worm gear 28 defining a positioning gear may be adapted to engage the ring gear 26 to determine the stroke of the piston 12 between an infinite number of different strokes within a predetermined range. A stepper motor 30 may cause movement of the worm gear 28, which may cause the ring gear 26 to rotate (e.g., 54). The stepper motor 30 may be in electronic communication with the battery, and electronic controls may cause the stepper motor 30 to drive the worm gear 28 in a forward or backward angular direction (e.g., clockwise or counterclockwise direction). In this particular embodiment, the worm gear 28, actuatable by the stepper motor 30, is adapted to engage corresponding gear teeth 27 positioned on a portion of an outer perimeter of the ring gear 26 to cause the ring gear to rotate 54 a limited angular amount resulting in a change to the pathway of an off-center axle of the planetary gear 20. The aforementioned change to pathway causes a change to the driving motion of the connecting rod 18, which in turn changes the stroke of the piston 12.

Positioned at the rear 32 of the device 10 may be a central controller. The central controller may comprise a digital screen, such as by way of example and not limitation, a touch screen. The central controller may additionally or alternatively comprise a plurality of buttons, rotatable dials, rotatable knobs, some combination thereof, or the like. The central controller at the rear 32 of the device 10 may provide a user the ability to specify and/or adjust amplitude and/or frequency of piston 12 movement in real time, including by way of example and not limitation, before or during a percussive therapy session. By way of example and not limitation, the central controller may provide a user control of worm gear 28 positioning by way of the stepper motor 30 to determine ring gear 26 positioning, which may dictate planetary gear 20 off-center axle movement, which may dictate stroke length. In the embodiment shown, the ring gear 26 remains stationary during percussive treatment other than to adjust the stroke of the device 10.

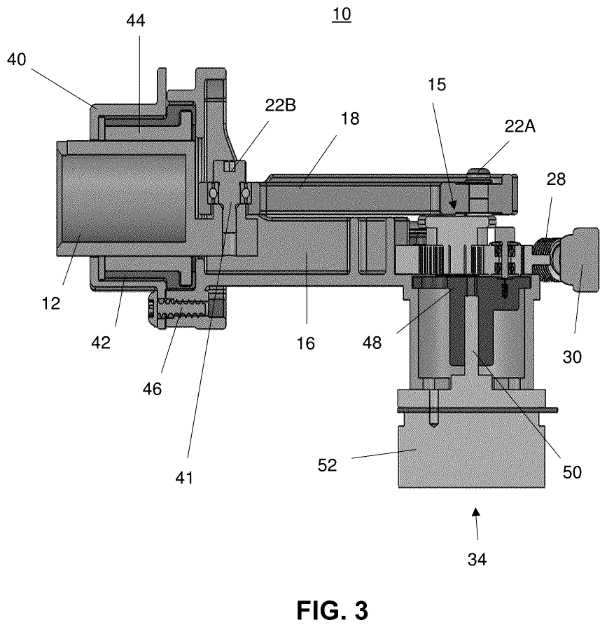

Referring to FIG. 3, a bushing (e.g., 40, 42, 44) may be adapted to cause the piston 12 to move from a retracted position to an extended position in a linear fashion. In this particular embodiment, the bushing comprises a bushing retainer 40, adapted to surround and restrict movement of a lubricated bushing 44. The lubricated bushing 44 may be positioned adjacent to the piston 12 substantially around a circumference thereof, and the piston 12 may be adapted to slide along an interior surface of the lubricated bushing 44. A vibration isolator or elastomer 42 may be positioned between the bushing retainer 40 and lubricated bushing 44, and may be adapted to restrict the propagation of vibrations within the device 10 from piston 12 movement. The bushing may be affixed to the frame 16 of the device 10 by any number of different fasteners (e.g., 46), clips, bolts, welding, adhesive, some combination thereof, or the like. In this particular embodiment, a second bearing 22B of a connection rod 18 opposite of a first bearing 22A includes an attachment member 41 positioned therein, wherein the attachment member 41 may be adapted to secure the connection rod 18 to the piston 12. Thus, movement of the connection rod 18 caused by rotation of an eccentric drive unit 48 may cause movement of the piston 12 secured to the connection rod 18.

Referring now to FIGS. 3-5, various views of the device 10 of the FIG. 1 embodiment are shown, the device 10 having a gear assembly 15 and a piston 12. A drive motor axle or rotating motor shaft 50 of the device 10 may be adapted to rotate upon actuation by a drive motor 52 positioned on the handle 34 of the device 10. Rotation of the rotating motor shaft 50 may cause rotation of an eccentric drive unit 48 attached thereto. The eccentric drive unit 48 may include an off-center axle configured to contact the planetary gear 20 and cause the planetary gear 20 to rotate and orbit along an inner circumference of the ring gear 26. The aforementioned movement of the planetary gear 20 may cause the planetary gear 20 off-center axle to move in a substantially ellipsoidal or substantially linear path. Movement of the planetary gear 20 off-center axle may dictate movement of the connecting rod 18 attached thereto at bearing 22A. Movement of the connecting rod 18 may drive the piston 12 in a linear, reciprocating motion resulting in a stroke thereof. Adjusting rotation of the eccentric drive unit 48 in real time by adjusting drive motor 52 power to the rotating motor shaft 50 may directly change piston 12 movement frequency in real time.

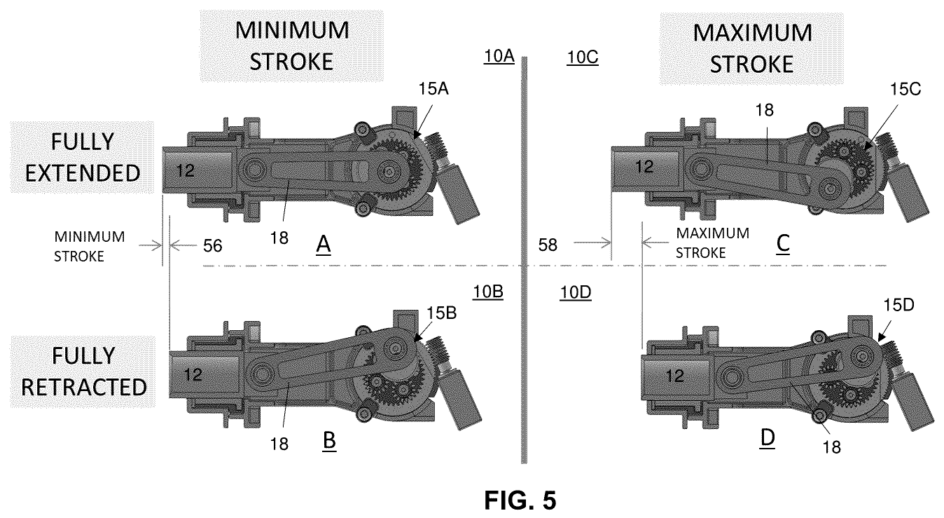

Rotation 54 of the ring gear 26 in real time caused by rotation of the worm gear 28 (actuated by the stepper motor 30) in a first direction may cause the planetary gear 20 axle (positioned within bearing 22A) to be positioned within the ring gear 26 closer to the front of the device when the device 10 is in a fully extended position, resulting in a greater stroke of the piston 12 (as shown by 10C in FIG. 5). Rotation 54 of the ring gear 26 in real time caused by rotation of the worm gear 28 in a second direction opposite of the first direction may cause the planetary gear 20 axle to be positioned within the ring gear 26 further from the front of the device when the device 10 is in a fully extended position, resulting in a smaller stroke of the piston 12 (as shown by 10A in FIG. 5).

Referring specifically to FIG. 5, the device 10A-B comprising a piston 12, connecting rod 18, and gear assembly 15A-B may exhibit a smaller or minimum stroke 56 between a fully extended A and fully retracted B position when the ring gear is rotated counterclockwise such that the worm gear is positioned lower on the ring gear. The device 10C-D comprising a piston 12, connecting rod 18, and gear assembly 15C-D may exhibit a larger or maximum stroke 58 between a fully extended C and fully retracted D position when the ring gear is rotated clockwise such that the worm gear is positioned higher on the ring gear. Referring again to FIGS. 3-5, the ring gear 26 may be rotated to one of any infinite number of different positions within a predetermined range in real time by action of a positioning gear (e.g., worm gear 28), thus the connecting rod 18 may move between an infinite number of different pathways (within a predetermined range), resulting in an infinite number of different available strokes (e.g., 56, 58) within a predetermined range of the piston 12. In exemplary embodiments, movement of the positioning gear (e.g., 28) may be achieved by a button, a stepper motor, a rotatable dial, a rotatable nob, a touch screen control, some combination thereof, or the like.

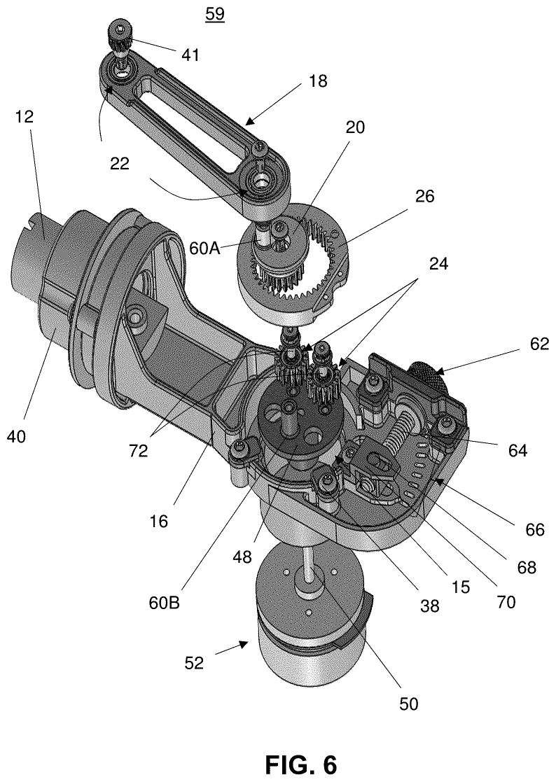

Referring now to FIGS. 6-9, an alternative exemplary device 59 having a bolt positioning gear 64 is shown. In this particular embodiment, the bolt positioning gear 64 may be controlled by a stroke adjustment knob 62. It will be apparent to one of ordinary skill in the art that the present invention is not intended to be limited to either stroke adjustment knobs for controlling bolt positioning gears or stepper motors for controlling worm gears. In other embodiments, there may be any number of different devices or methods available for causing rotation of a ring gear to adjust stroke.

In the embodiment shown, the stroke adjustment knob 62 is adapted to rotate in a first direction (e.g., clockwise or counterclockwise) to move a ring gear engagement apparatus 70 towards the stroke adjustment knob 62, and the stroke adjustment knob 62 is adapted to rotate in a second direction opposite of the first direction to move the ring gear engagement apparatus 70 away from the stroke adjustment knob 62. A connection apparatus 68 may include a threaded slide bushing portion having complimentary threads with respect to the bolt positioning gear 64. Rotation of the bolt positioning gear 64 may cause the connection apparatus 68 to move along the bolt positioning gear 64 in either direction by engagement of the complimentary threads with one another. The connection apparatus 68 may be connected to the ring gear engagement apparatus 70 such that movement of the connection apparatus 68 in either direction along the bolt positioning gear 64 causes rotation of the ring gear engagement apparatus 70. In the embodiment shown, the ring gear engagement apparatus 70 is a bracket rigidly secured to the ring gear 26 by a fastener.

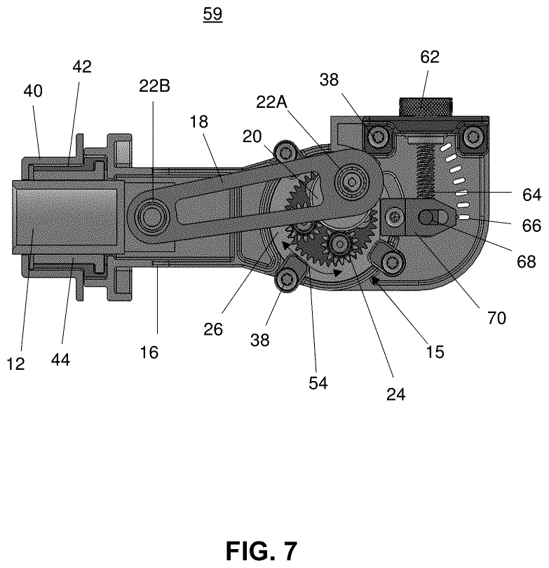

Rotation of the ring gear apparatus 70 in a first direction (e.g., away from the stroke adjustment knob 62) may cause the ring gear 26 to rotate clockwise (e.g., 54), and rotation of the ring gear apparatus 70 in a second direction (e.g., towards the stroke adjustment knob 62) may cause the ring gear 26 to rotate counterclockwise (e.g., 54). In the embodiment shown, the ring gear 26 is adapted to rotate a limited angular range to dictate piston 12 stroke. The ring gear engagement apparatus 70 and the ring gear 26 may each remain substantially stationary before or during percussive therapy until a user engages the stroke adjustment knob 62 to regulate stroke. In the embodiment shown, a locking mechanism for the ring gear 26 is not required. Referring specifically to FIG. 7, the ring gear 26 and ring gear engagement apparatus 70 are shown in position for providing maximum stroke to the piston 12.

Referring again to FIGS. 6-9, a drive motor axle or rotating motor shaft 50 is positioned above a drive motor 52, and is powered by the drive motor 52. It will be apparent to one of ordinary skill in the art that there may be any number of different methods or devices available for actuating a rotating motor shaft without departing from the scope of the present invention. An aperture in the frame 16 securing the gear assembly 15 may permit the drive motor axle 50 to pass therethrough. Positioned below the gear assembly 15 and above the drive motor 52 may be an eccentric drive unit 48, wherein a portion of the eccentric drive unit 48 may be adapted to receive a portion of the drive motor axle 50 and attach the drive motor axle 50 thereto. Thus, the eccentric drive unit 48 may rotate as the drive motor axle 50 rotates.

An off-center axle 60B may be positioned on the eccentric drive unit 48 on a face of the eccentric drive unit 48 opposite of the drive motor 52. A central portion of the planetary gear 20 may be adapted to receive the off-center axle 60B of the eccentric drive unit 48. Thus, the planetary gear 20 may orbit within the ring gear 26 as the eccentric drive unit 48 rotates. Bearings may be incorporated adjacent to any axle connections to reduce friction between component parts. Idler gears 24 are preferably included to, for example by way of illustration and not limitation, reduce the impact of the gear assembly 15 on the drive motor axle 50. The idler gears 24 may comprise bearings 72 for reducing friction between the idler gears 24 and shafts connecting the idler gears 24 to the eccentric drive unit 48. It will be apparent to one of ordinary skill in the art that exemplary embodiments of the present invention are not necessarily intended to be limited to any particular number, shape, or size of any gear, bearing, motor, part, component, or the like identified herein.

Gear teeth may be positioned along the lower outer perimeter of the planetary gear 20 to engage gear teeth along an inner circumference of the ring gear 26. An off-center axle 60A may be positioned on a planetary gear 20 face opposite of the planetary gear 20 teeth. The gear assembly 15 may be attached to the frame 16 by one or more fasteners 38. The rotatable position of the ring gear 26 may dictate where the off-center axle 60A is positioned when the planetary gear 20 is positioned to cause maximum extension of a piston 12 contained by a bushing (e.g., 40, 42, 44). The rotatable position of the ring gear 26 may be measured by a plurality of stroke setting indicators 66. In the embodiment shown, when the off-center axle 60A is caused by the ring gear 26 to travel a first path 74A, the piston 12 extends farther from the bushing (e.g., 40, 42, 44) in its maximum extended position, resulting in greater stroke of the device 59. When the off-center axle 60A is caused by the ring gear 26 to travel a second path 74B, the piston 12 extend less far from the bushing (e.g., 40, 42, 44) in its maximum extended position, resulting in a smaller stroke of the device 59. With the second path 74B, a maximum extended position of the piston 12 may occur when the off-center axle 60A is positioned substantially at a centerline 78B of the bushing (e.g., 40, 42, 44). In the embodiment shown, a connecting rod 18 having a bearing 22A adapted to receive the off-center axle 60A and reduce friction therebetween drives movement of the piston 12. The connecting rod 18 may adapted to engage in reciprocal, substantially linear movement between the gear assembly 15 and the bushing, wherein reciprocal, substantially linear movement of the connecting rod 18 may be caused by movement of the off-center axle 60A of the planetary gear 20. An end of the connection rod 18 opposite of the planetary gear 20 may include another bearing 22B for receiving an attachment member 41 adapted to connect the connection rod 18 to the piston 12. Thus, the reciprocal, substantially linear movement of the connecting rod 18 may cause reciprocal, linear motion of the piston 12, resulting in a stroke corresponding to the stroke setting.

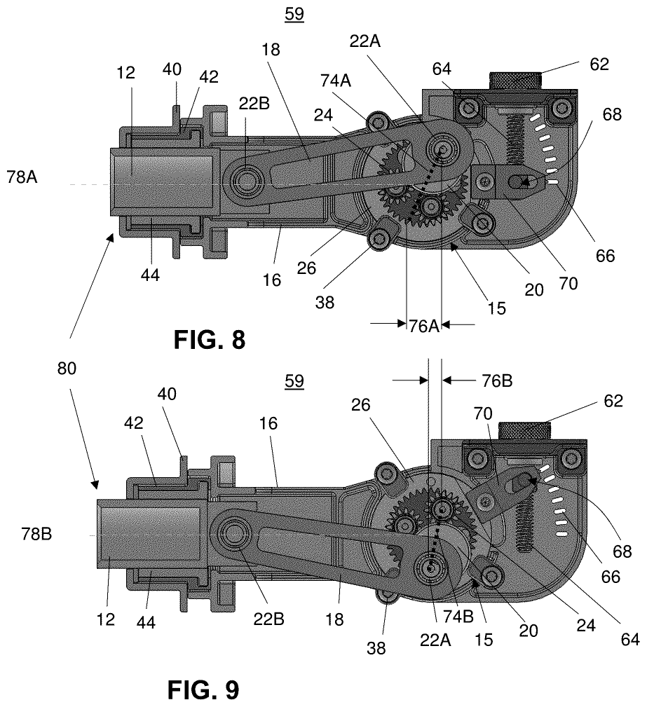

Referring specifically to FIGS. 6, 8, and 9, path lines 74A and 74B illustrate the path of the planetary gear axle 60A during a single stroke of the piston 12. Referring specifically to FIG. 8, the ring gear engagement apparatus 70 is positioned to cause a maximum amplitude (as illustrated by centerline 78A illustrating approximately how far past the bushing retainer 40 the piston 12 may travel). Referring specifically to FIG. 9, the ring gear engagement apparatus 70 is positioned to cause a minimum amplitude (as illustrated by centerline 78B illustrating approximately how far past the bushing retainer 40 the piston 12 may travel). It will be apparent to one of ordinary skill in the art that the aforementioned figures are merely illustrative, and exemplary embodiments of the present invention are not necessarily intended to be limited to any particular minimum or maximum amplitude based on positioning gear configuration.

Referring again to the FIGS. 6, 8, and 9 embodiments, the stroke (e.g., 76A, 76B) of the piston 12 may be equal to the maximum difference in distance of the position of the planetary gear axle 60A when it is closest to and farthest from the front 80 of the device 59, measured parallel to the piston 12 stroke (maximum difference in distance is illustrated by 76A and 76B). It will be apparent to one of ordinary skill in the art, however, that in other embodiments, stroke is not necessarily limited to the maximum difference in distance of the position of the planetary gear axle when it is closest to and farthest from the front of the device, measured parallel to the piston stroke. By way of example and not limitation, the connecting rod may not necessarily be restricted to substantially horizontal movement, and may be adapted for upward and/or downward angular movement to cause retraction of the piston. In the embodiment shown, the maximum difference in distance 76A for FIG. 8 is greater than the maximum difference in distance 76B for FIG. 9, thus stroke of the device 59 is greater in FIG. 8 than it is in FIG. 9. In certain embodiments, the device may be configured for variable stroke velocity, where the piston 12 may retract faster than it advances, or vice versa. The shape of the path (e.g., 74A, 74B) of the planetary gear off-center axle 60A may permit the piston 12 to advance faster than it retracts or vice versa when motor action is altered during a single stroke, such as when, for example not by way of limitation, rotation direction of the eccentric drive unit 48 is reversed. It will be apparent to one of ordinary skill in the art that exemplary embodiments of the present invention are not necessarily intended to be limited to any particular stroke velocity.

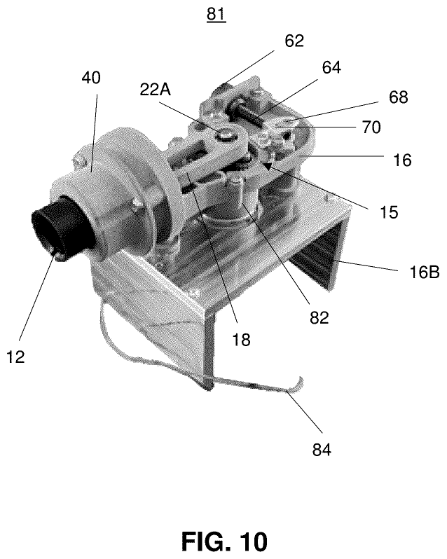

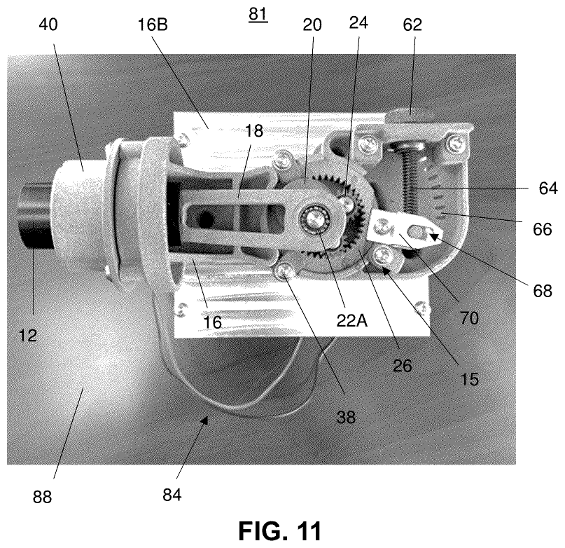

Referring now to FIGS. 10-11, another exemplary real time infinitely adjustable amplitude and adjustable frequency percussive therapy device 81 is shown having a piston 12, frame 16, bushing retainer 40, bearings (e.g., 22A), a connecting rod 18, a gear assembly 15 (including planetary gear 20, idler gears 24, ring gear 26, bolt positioning gear 64) secured (e.g., by fasteners 38) to the frame 16, stroke adjustment knob 62, stroke setting indicators 66, connection apparatus 68 and ring gear engagement apparatus 70. In this particular embodiment, the device 81 is adapted to be supported by a supporting frame 16B over a substantially flat surface 88. Also, in this particular embodiment, a motor shaft 82 including a drive motor and drive motor axle therein is shown. Furthermore, in this particular embodiment, the device 81 comprises wires 84 permitting power requirements for any number of different motors or other electronic components, including by way of example and not limitation, a digital display, of the device 81 to be satisfied. In certain embodiments, the device 81 may be adapted to permit vibrations and/or other movement of the reciprocating member (e.g., piston 12) and/or an attachment thereto. By way of example and not limitation, an exemplary device may be configured to permit control of throw of the reciprocating member movement in addition to amplitude and frequency of reciprocating member movement. Throw for local vibrations of an exemplary reciprocating member and/or attachment thereto maybe 0.5-1.5 mm in certain embodiments. It will be apparent to one of ordinary skill in the art that with exemplary embodiments of the present invention, local vibration throw is not necessarily intended to be limited to any particular range.

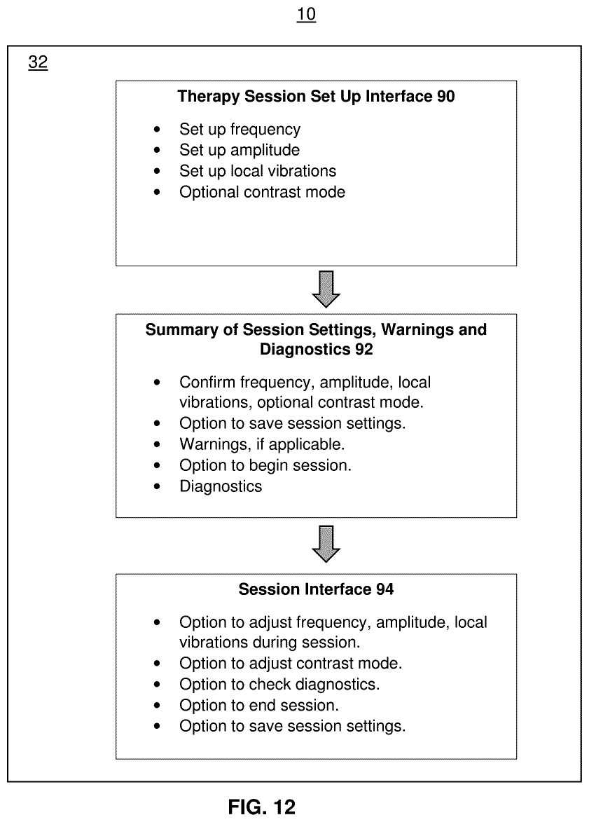

Referring now to FIGS. 6 and 12, exemplary logic for various device interfaces in accordance with a preferred embodiment of the present invention is shown. The drive motor may be adapted to cause the eccentric drive unit to rotate at any number of different velocities, and thus any number of different frequencies for reciprocating member movement may be available. Rotation of the eccentric drive unit, and thus frequency of reciprocating member movement, may be adjusted in real time, including by way of example and not limitation, during an ongoing percussive therapy session, by a central controller. The central controller may include a microprocessor and one or more digital interfaces displayed at a rear screen 32 of the device (e.g., 10, 59). Stroke and local vibration settings may also be adjusted according to the central control before and/or during a percussive therapy session.

The digital interfaces may include a therapy session set up interface 90, a summary of session settings, warnings and diagnostics interface 92 and a session interface 94. The set-up interface 90 may permit a user to specify frequency, amplitude, local vibrations, some combination thereof, or the like before a therapy session, and may further permit a user to specify how frequency, amplitude, local vibrations, some combination thereof, or the like change over time during a therapy session (“optional contrast mode”). The settings, warnings and diagnostics interface 92 may provide an option to confirm aforementioned specifications, save aforementioned specifications for later use, some combination thereof, or the like. The settings, warnings and diagnostics interface 92 may further provide any warnings applicable to certain uses of the device, such as by way of example and not limitation, warnings about prolonged use of the device, especially at high amplitudes and frequencies, and diagnostics options, such as by way of example and not limitation, options to view device performance characteristics. The session interface 94 may provide options to adjust any aforementioned parameters during a therapy session, end a therapy session, save settings from the therapy session, some combination thereof, or the like. The aforementioned interfaces are meant to be merely illustrative and not exhaustive of examples of device programming.

The aforementioned parameters may be varied throughout a massage session utilizing a programmed “user profile” or any number of different pre-programmed settings to vary the motor speed and reciprocating member movement frequency, stroke (e.g., stepper motor action, positioning gear configuration), local vibrations of the reciprocating member and/or attachments thereof, some combination thereof, or the like. In certain embodiments, the rate of velocity of the drive axle, and in turn reciprocating member movement frequency in percussions per minute (ppm) may be adjusted according to an electronic touch pad, tactile switches, one or more dials or the like. It will be apparent to one of ordinary skill in the art that there may be any number of different devices or methods available for varying the rate of velocity of a drive axle without departing from the scope of the present invention. In certain embodiments, stroke may be adjusted within a range of 0.5 mm to 20 mm, wherein the adjustment may be actuated mechanically, electronically, or by some combination of mechanical and electronic actuation. In certain embodiments, reciprocating member movement frequency may be adjusted within a range of 1200 ppm and 7200 ppm, wherein buttons, dials, digital interfaces, some combination thereof, or the like, preferably positioned at or near the rear of the device, may permit frequency adjustment. It will be apparent to one of ordinary skill in the art that exemplary embodiments of the present invention are not necessarily intended to be limited to any particular frequency or stroke range.

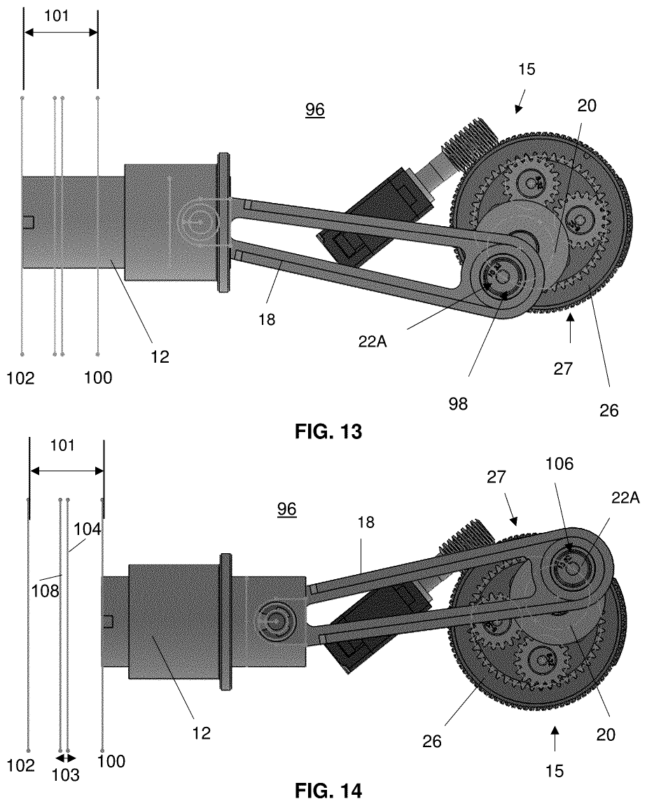

Referring now to FIGS. 13-14, an exemplary device 96 having a gear assembly 15 including a ring gear 26 comprising a plurality of gear teeth 27 positioned substantially across an outer circumference of the ring gear 26 is shown. Referring specifically to FIG. 13, a planetary gear 20 off-center axle substantially positioned in a first bearing 22A of a connection rod 18 is located at a midpoint 98 of an off-center axle movement path corresponding to a midpoint of a motor revolution. The off-center axle movement path may be substantially linear. Here, the front of the piston 12 is at a fully extended position 102, and displacement (stroke) 101 of the piston 12 from a retracted position 100 to the fully extended position 102 is a maximum value 101. The maximum value 101 may be 20 mm. A single percussion of the device 96 may occur when the piston 12 moves from the retracted position 100 to the extended position 102 and back to the retracted position 100.

Referring specifically to FIG. 14, the planetary gear 20 off-center axle substantially positioned in the first bearing 22A of the connection rod 18 is located at a starting part 106 of an off-center axle movement path corresponding to a starting point of a motor revolution. Here, the front of the piston 12 is at a fully retracted position 100 located a distance 101 from the fully extended position 102. By way of example and not limitation, the position of the ring gear 26 may be adjusted to cause displacement 103 of the piston 12 from another fully retracted position 104 to another fully extended position 108 to be a minimum value 103. The minimum value 103 may be 0.5 mm. In certain embodiments, the minimum stroke setting results in two percussions of a substantially similar amplitude corresponding to one motor revolution (“multiplier effect”). By way of example and not limitation, at a minimum stroke of 0.5 mm, the motor may be configured to rotate at 3600 rpm, which, according to the aforementioned multiplier effect, may result in a frequency of 7200 ppm. The significant increase in frequency caused by the multiplier effect may be advantageous to the patient by greatly increasing number of percussions to a treatment area over a period of time. In other embodiments, the multiplier effect occurs when stroke is set to approximately 2 mm. It will be apparent to one of ordinary skill in the art that the multiplier effect is not necessarily limited to occurring at any single particular amplitude.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

What is claimed is:

1. An adjustable percussive therapy device comprising:
a plurality of gears, including a positioning gear;
a reciprocating member;
a connecting rod;
a motor;
wherein one or more of the plurality of gears are adapted to regulate motion of the connecting rod;
wherein the reciprocating member is adapted to engage in reciprocal motion when the connecting rod is in motion;
and
wherein the positioning gear is adapted to permit reciprocal motion of the reciprocating member to be adjusted between a great number of different amplitudes across a range of amplitudes during active operation.

2. The device of claim 1, further comprising:
a planetary gear;
a drive unit;
wherein rotation of the drive unit is adapted to cause motion of the planetary gear; and
wherein the planetary gear is adapted to cause motion of the connecting rod when the planetary gear is in motion.

3. The device of claim 2, further comprising:
a ring gear, adapted to substantially restrict motion of the planetary gear to within an interior perimeter thereof.

4. The device of claim 2, wherein:
the motor is adapted to cause rotation of the drive unit.

5. The device of claim 3, further comprising:
a cushioning device, positioned adjacent to the planetary gear, and configured to move within an interior perimeter of the ring gear.

6. The device of claim 1, wherein:
the reciprocating member is further configured to vibrate.

7. The device of claim 3, wherein:
the positioning gear is adapted to adjust the ring gear to permit reciprocal motion of the reciprocating member to be adjusted between an unlimited number of different amplitudes while the device is active.

8. The device of claim 1, wherein:
the positioning gear comprises a worm gear adapted to be rotated by a stepper motor.

9. The device of claim 1, wherein:
the positioning gear comprises a threaded shank adapted to be rotated by a stroke adjustment knob.

10. An adjustable percussive therapy device comprising:
a positioning gear;
a ring gear;
a planetary gear;
a drive unit;
a connecting rod;
a piston;
a motor;
wherein the motor is adapted to cause rotation of the drive unit;
wherein rotation of the drive unit is adapted to cause motion of the planetary gear substantially within an interior perimeter of the ring gear;
wherein the planetary gear is adapted to cause motion of the connecting rod when the planetary gear is in motion;
wherein the piston is adapted to engage in reciprocal motion when the connecting rod is in motion;
wherein the motor is adapted to permit reciprocal motion of the piston to be adjusted between a number of different frequencies while the device is active; and
wherein the positioning gear is adapted to adjust the ring gear to permit reciprocal motion of the piston to be adjusted between an unlimited number of different amplitudes while the device is active.

11. The device of claim 10, wherein:
at least one selected from the group of the piston and an attachment received by the piston are configured to vibrate while the device is active.

12. The device of claim 10, further comprising:
a bushing configured to regulate reciprocal motion of the piston.

13. The device of claim 10, further comprising:
a cushioning device, positioned adjacent to the planetary gear, and configured to move within an interior perimeter of the ring gear.

14. The device of claim 10, wherein:
the positioning gear is adapted to adjust the ring gear to a multiplier effect position to cause two percussions of the piston to occur concurrent to one rotation of the drive unit.

15. A method for providing percussive tissue therapy comprising:
providing a plurality of gears, including a positioning gear;
providing a piston;
providing a connecting rod;
providing a motor;
configuring one or more of the plurality of gears to regulate motion of the connecting rod;
configuring the piston to engage in reciprocal motion when the connecting rod is in motion;
configuring the motor to permit reciprocal motion of the piston to be adjusted between a number of different frequencies while the device is active; and
configuring the positioning gear to permit reciprocal motion of the piston to be adjusted between an unlimited number of different amplitudes.

16. The method of claim 15, further comprising:
providing a planetary gear;
wherein the planetary gear comprises a planetary gear axle adapted to actuate movement of the connecting rod.

17. The method of claim 15, wherein:
the positioning gear comprises a worm gear.

18. The method of claim 15, wherein:
the positioning gear comprises a threaded shank adapted to be rotated by a stroke adjustment knob.

19. The method of claim 16, further comprising:
providing a drive unit; and
configuring the drive unit to cause rotation of the planetary gear.

20. The method of claim 16, further comprising:
providing a ring gear, adapted to substantially restrict motion of the planetary gear to within an interior perimeter thereof; and
configuring the positioning gear to be in mechanical communication with the ring gear to permit reciprocal motion of the piston to be adjusted between an unlimited number of different amplitudes.
